(19) United States
(12) Patent Application Publication
(10) Pub. No.: US 2010/0197486 A1
(43) Pub. Date: Aug. 5, 2010

(54) CATALYSTS FOR MAKING ETHYL ACETATE FROM ACETIC ACID

(75) Inventors: Victor J. Johnston, Houston, TX (US); Laiyuan Chen, Houston, TX (US); Barbara F. Kimmich, Bernardsville, NJ (US); Josefina T. Chapman, Houston, TX (US); James H. Zink, League City, TX (US); Heiko Weiner, Pasadena, TX (US); John L. Potts, Angleton, TX (US); Radmila Jevtic, Houston, TX (US)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: CELANESE INTERNATIONAL CORPORATION, Dallas, TX (US)

(21) Appl. No.: 12/699,029

(22) Filed: Feb. 2, 2010

Related U.S. Application Data
(63) Continuation-in-part of application No. 12/588,727, filed on Oct. 26, 2009.
Application No. 12/588,727 is a continuation-in-part of application No. 12/221,209, filed on Jul. 31, 2008.
Application No. 12/221,209 is a continuation-in-part of application No. 12/221,141, filed on Jul. 31, 2008.

(51) Int. Cl. B01J 23/62; B01J 21/08; B01J 23/68

(52) U.S. Cl. 502/241; 502/242

(57) ABSTRACT

Catalysts and processes for making catalysts suitable for use in processes for hydrogenating acetic acid to form of ethyl acetate and mixtures of ethyl acetate and ethanol. In a first embodiment, the catalyst includes a high loading of nickel, palladium or platinum. In a second embodiment, the catalyst comprises a first metal selected from nickel and palladium and a second metal selected from tin and zinc. In a third embodiment, the catalyst comprises one or more metals on a support that has been modified with an acidic support modifier or a redox support modifier.

### CROSS REFERENCE TO RELATED APPLICATIONS

This is a continuation-in-part of U.S. application Ser. No. 12/588,727, filed Oct. 26, 2009, entitled “Tunable Catalyst Gas Phase Hydrogenation of Carboxylic Acids,” of U.S. application Ser. No. 12/221,209, filed Jul. 31, 2008, entitled “Direct and Selective Production of Ethyl Acetate from Acetic Acid Utilizing a Bimetal Supported Catalyst,” and of U.S. application Ser. No. 12/221,141, filed Jul. 31, 2008, entitled “Direct and Selective Production of Ethanol from Acetic Acid Utilizing a Platinum/Tin Catalyst,” the entireties of which are incorporated herein by reference.

### FIELD OF THE INVENTION

The present invention relates generally to catalysts and processes for making catalysts for use in processes for hydrogenating acetic acid to form ethyl acetate or a mixture of ethyl acetate and ethanol, the catalysts having high selectivities for ethyl acetate.

### BACKGROUND OF THE INVENTION

There is a long felt need for an economically viable catalysts and processes for converting acetic acid to ethyl acetate. Ethyl acetate is an important commodity feedstock for a variety of industrial products and is also used as an industrial solvent in the manufacture of various chemicals. For instance, ethyl acetate can readily be converted to ethylene by subjecting it to a cracking process, which can then be converted to a variety of other products. Ethyl acetate is conventionally produced from feedstocks where price fluctuations are becoming more significant. That is, fluctuating natural gas and crude oil prices contribute to fluctuations in the cost of conventionally produced, petroleum or natural gas-sourced ethyl acetate, making the need for alternative sources of ethyl acetate all the greater when oil prices rise.

Ethanol is another important commodity chemical, which may be used in its own right, for example as a fuel, or as a feedstock for forming ethylene, vinyl acetate, ethyl acetate, or other chemical products. The hydrogenation of carboxylic acids over heterogeneous catalysts to produce alcohols is well reported. For instance, U.S. Pat. No. 2,607,807 discloses that ethanol can be formed from acetic acid over a ruthenium catalyst at extremely high pressures of 700-950 bar in order to achieve yields of around 88%, whereas low yields of only about 40% are obtained at pressures of about 200 bar. However such extreme reaction conditions are unacceptable and uneconomical for a commercial operation.

More recently, even though it may not still be commercially viable it has been reported that ethanol can be produced from hydrogenating acetic acid using a cobalt catalyst at superatmospheric pressures such as about 40 to 120 bar. See, for example, U.S. Pat. No. 4,517,391 to Shuster et al.

On the other hand, U.S. Pat. No. 5,149,680 to Kitson et al. describes a process for the catalytic hydrogenation of carboxylic acids and their anhydrides to alcohols and/or esters utilizing a platinum group metal alloy catalyst. The catalyst is comprised of an alloy of at least one noble metal of Group VIII of the Periodic Table and at least one metal capable of alloying with the Group VIII noble metal, admixed with a component comprising at least one of the metals rhenium, tungsten or molybdenum. Although it has been claimed therein that improved selectivity to a mixture of alcohol and its ester with the unreacted carboxylic acid is achieved over the prior art references it was still reported that 3 to 9 percent of alkanes, such as methane and ethane are formed as by-products during the hydrogenation of acetic acid to ethanol under their optimal catalyst conditions.

A slightly modified process for the preparation of ethyl acetate by hydrogenating acetic acid has been reported in EP 0 372 847. In this process, a carboxylic acid ester, such as for example, ethyl acetate is produced at a selectivity of greater than 50% while producing the corresponding alcohol at a selectivity less than 10% from a carboxylic acid or anhydride thereof by reacting the acid or anhydride with hydrogen at elevated temperature in the presence of a catalyst composition comprising as a first component at least one of Group VIII noble metal and a second component comprising at least one of molybdenum, tungsten and rhenium and a third component comprising an oxide of a Group IVB element. However, even the optimal conditions reported therein result in significant amounts of by-products including methane, ethane, acetaldehyde and acetone in addition to ethanol. In addition, the conversion of acetic acid is generally low and is in the range of about 5 to 40% except for a few cases in which the conversion reached as high as 80%.

From the foregoing it is apparent that existing processes do not have the requisite selectivity to ethyl acetate and/or ethanol, employ highly expensive catalysts or produce undesirable by-products such as methane and ethane. Thus, the need exists for forming ethyl acetate (and optionally ethanol) at high selectivity using a more economical catalyst, while minimizing the formation of undesirable byproducts.

### SUMMARY OF THE INVENTION

The present invention is directed to catalysts and processes for making catalysts that are suitable for use processes for hydrogenating acetic acid to ethyl acetate, or optionally a mixture of ethyl acetate and ethanol, at high selectivity, conversion, and/or productivity.

In one embodiment, the catalyst comprises a first metal, a second metal and a support, wherein the first metal is selected from the group consisting of nickel, palladium and platinum and is present in an amount greater than 1 wt %, based on the total weight of the catalyst, and wherein the second metal is selected from the group consisting of molybdenum, rhenium, zirconium, copper, cobalt, tin, and zinc and wherein the catalyst has a selectivity to ethyl acetate of greater than 40%. Preferably, the first metal is present in an amount greater than 1 wt. % and less than 25 wt %, based on the total weight of the catalyst.

In another embodiment, the catalyst comprises a first metal, a second metal and a silica/alumina support, wherein the first metal is selected from the group consisting of nickel, palladium and platinum, the second metal is selected from the group consisting of molybdenum, rhenium, zirconium, copper, cobalt, tin, and zinc, and wherein the silica/alumina support comprises aluminum in an amount greater than 1 wt. %, based on the total weight of the high surface area silica/alumina support and has a surface area of at least 150 m²/g and wherein the catalyst has a selectivity to ethyl acetate of greater than 40%.

In another embodiment, the catalyst comprises a first metal, a support, and at least one support modifier selected from the group of oxides of Group IVB metals, oxides of Group VB metals, oxides of Group VIB metals, iron oxides, aluminum oxides and mixtures thereof. The first metal may be selected from the group consisting of Group IB, IIB, IIIB, IVB, VB, VIIB, VIIB, or VIII transitional metal, a lanthanide metal, an actinide metal or a metal from any of Groups IIIA, IVA, VA, or VIA. In anther embodiment, the first metal is selected from the group consisting of copper, iron, cobalt, nickel, ruthenium, rhodium, palladium, osmium, iridium, platinum, titanium, zinc, chromium, rhenium, molybdenum, and tungsten. In addition, the catalyst may comprise a second metal different from the first metal and optionally selected from the group consisting of copper, molybdenum, tin, chromium, iron, cobalt, vanadium, tungsten, palladium, platinum, lanthanum, cerium, manganese, ruthenium, rhenium, gold, and nickel. Preferably, the first metal is present in an amount from 0.1 to 25 wt. %, based on the total weight of the catalyst. More preferably, the first metal is platinum and the second metal is tin, optionally having a molar ratio of platinum to tin is from 0.65:0.35 to 0.95:0.05 or the first metal is palladium and the second metal is rhenium, optionally having a molar ratio of rhenium to palladium is from 0.65:0.35 to 0.95:0.05. As another option, the catalyst further comprises a third metal different from the first and second metals and being selected from the group consisting of cobalt, palladium, ruthenium, copper, zinc, platinum, tin, and rhenium. The third metal may be present in an amount of 0.05 and 4 wt. %, based on the total weight of the catalyst.

As noted above, the catalysts may, generally, be suitable for use as a hydrogenation catalyst in converting acetic acid to ethyl acetate and at least 10% of the acetic acid may be converted during hydrogenation. Also, the hydrogenation may be performed in a vapor phase at a temperature of from 125° C. to 350° C., a pressure of 10 KPa to 3000 KPa, and a hydrogen to acetic acid mole ratio of greater than 4:1. In addition, the catalysts may have a selectivity to ethyl acetate of greater than 40%, e.g., greater than 50%, and a selectivity to methane, ethane, and carbon dioxide of less than 4%. In one embodiment, the catalyst has a productivity that decreases less than 6% per 100 hours of catalyst usage.

In one embodiment, the support is present in an amount of 25 wt. % to 99 wt. %, based on the total weight of the catalyst and is selected from the group consisting of iron oxide, silica, alumina, silica/aluminas, titania, zirconia, magnesium oxide, calcium silicate, carbon, graphite, high surface area graphitized carbon, activated carbons, and mixtures thereof. As one option, the catalyst may comprise at least one support modifier selected from the group consisting of (i) alkaline earth metal oxides, (ii) alkali metal oxides, (iii) alkaline earth metal metasilicates, (iv) alkali metal metasilicates, (v) Group IIB metal oxides, (vi) Group IIB metal metasilicates, (vii) Group IIIB metal oxides, (viii) Group IIIB metal metasilicates, and mixtures thereof preferably being CaSiO₃. In another option the support modifier is selected from the group consisting of oxides of Group IVB metals, oxides of Group VB metals, oxides of Group VIB metals, iron oxides, aluminum oxides and mixtures thereof. As yet another option, the support modifier may be selected from the group consisting of WO₃, MoO₃, Fe₂O₃, Cr₂O₃, TiO₂, ZrO₂, Nb₂O₅, Ta₂O₅, and Al₂O₃. The support modifier may be present in an amount of 0.1 wt. % to 50 wt. %, based on the total weight of the catalyst.

In addition to the catalyst, the present invention also relates to process for preparing a catalyst, comprising (a) contacting a first metal precursor to a first metal with a support, wherein the first metal is selected from the group consisting of nickel, palladium and platinum; (b) contacting a second metal precursor to a second metal with the support, wherein the second metal is selected from the group consisting of molybdenum, rhenium, zirconium, copper, cobalt, tin, and zinc; and (c) heating the support under conditions effective to reduce the first metal and the second metal and form the catalyst, wherein the catalyst comprises the first metal in an amount greater than 1 wt %, based on the total weight of the catalyst.

In another embodiment, the present invention relates to a process for preparing a catalyst, comprising (a) contacting a first metal precursor to a first metal with a support, wherein the first metal is selected from the group consisting of nickel and palladium; (b) contacting a second metal precursor to a second metal with the support, wherein the second metal is selected from the group consisting of tin and zinc; and (c) heating the support under conditions effective to reduce the first metal and the second metal and form the catalyst.

In yet another embodiment, the present invention relates to a process for preparing a catalyst, the process comprising the steps of (a) contacting a first metal precursor to a first metal with a modified support comprising at least one support modifier selected from the group of oxides of Group IVB metals, oxides of Group VB metals, oxides of Group VIB metals, iron oxides, aluminum oxides and mixtures thereof; and (b) heating the modified support under conditions effective to reduce the first metal and form the catalyst, wherein the catalyst has a selectivity to ethyl acetate of greater than 40%. Preferably, the process further comprises the steps of (c) contacting the at least one support modifier or a precursor thereof with a support material to form a modified support precursor; and (d) heating the modified support precursor under conditions effective to form the modified support.

Preferably, the heating occurs between steps (a) and (b) to reduce the first metal and/or after steps (a) and (b) to reduce the second metal. Optionally, step (b) occurs before step (a).

### BRIEF DESCRIPTION OF DRAWINGS

The invention is described in detail below with reference to the appended drawings, wherein like numerals designate similar parts.

FIG. 1A is a graph of the selectivity to ethanol and ethyl acetate using a SiO₂—PtₘSn₁₋ₘ catalyst;

FIG. 1B is a graph of the productivity to ethanol and ethyl acetate of the catalyst of FIG. 1A;

FIG. 1C is a graph of the conversion of the acetic acid of the catalyst of FIG. 1A;

FIG. 2A is a graph of the selectivity to ethanol and ethyl acetate using a SiO₂—ReₙPd₁₋ₙ catalyst;

FIG. 2B is a graph of the productivity to ethanol and ethyl acetate of the catalyst of FIG. 2A;

FIG. 2C is a graph of the conversion of the acetic acid of the catalyst of FIG. 2A;

FIG. 3 is a graph of the activity of a catalyst compared to the productivity of the catalyst to a mixture of ethyl acetate and ethanol at various temperatures according to one embodiment of the invention; and

FIG. 4 is a graph of the activity of a catalyst compared to the selectivity of the catalyst to a mixture of ethyl acetate and ethanol at various temperatures according to one embodiment of the invention.

### DETAILED DESCRIPTION OF THE INVENTION

### Introduction

The present invention relates to catalysts for use in processes for producing ethyl acetate or a mixture of ethyl acetate and ethanol by hydrogenating acetic acid. The present invention also relates to processes for making these catalysts.

The hydrogenation of acetic acid to form ethyl acetate may be represented by the following reaction:

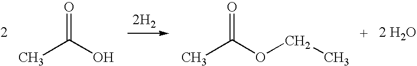

Depending on the catalyst and process conditions employed, the hydrogenation reaction may produce ethanol in addition to ethyl acetate. Embodiments of the present invention beneficially may be used in industrial applications to produce ethyl acetate and/or ethanol on an economically feasible scale.

Typically, the catalyst will comprises a first metal and optionally one or more of a second metal, a third metal, and optionally additional metals. The one or more metals preferably are disposed on a support, such as silica or titania. In a first embodiment, the catalyst includes a high loading of nickel, palladium or platinum. In a second embodiment, the catalyst comprises a first metal selected from nickel and palladium and a second metal selected from tin and zinc. In a third embodiment, the catalyst comprises one or more metals on a support that has been modified with an acidic support modifier or a redox support modifier. It has now been discovered that these catalyst compositions surprisingly and unexpectedly can be formulated to be selective for the formation of ethyl acetate, optionally in combination with ethanol.

### High Loading Nickel, Palladium and Platinum Catalysts

In a first embodiment, the invention is to a catalyst that comprises one or more of nickel, palladium or platinum at high metal loadings. For example, the catalyst may comprise a first metal selected from the group consisting of nickel, palladium, and platinum on a support in an amount greater than 1 wt. %, e.g., greater than 1.1 wt. %, or greater than 1.2 wt. %, based on the total weight of the catalyst. In terms of ranges, the amount of the first metal on the support preferably is from 1 to 25 wt. %, e.g., from 1.2 to 15 wt. %, or from 1.5 wt. % to 10 wt. %. For purposes of the present specification, unless otherwise indicated, weight percent is based on the total weight the catalyst including metal and support.

The metal(s) in the catalyst may be present in the form of one or more elemental metals and/or one or more metal oxides. For purposes of determining the weight percent of the metal(s) in the catalyst, the weight of any oxygen that is bound to the metal is ignored. In a more preferred aspect, the first metal is selected from platinum and palladium. When the first metal comprises platinum, it is preferred that the catalyst comprises the platinum in an amount greater than 1 wt. %, but less than 10 wt. %, e.g., less than 5 wt. % or less than 3 wt. %, due to the availability of platinum.

In addition to the first metal, the catalyst of the invention optionally further comprises one or more of a second metal, a third metal or additional metals. In this context, the numerical terms “first,” “second,” “third,” etc., when used to modify the word “metal,” are meant to indicate that the respective metals are different from one another. If present, the second metal preferably is selected from the group consisting of molybdenum, rhenium, zirconium, copper, cobalt, tin, and zinc. More preferably, the second metal is selected from the group consisting of molybdenum, rhenium, tin and cobalt. Even more preferably, the second metal is selected from tin and rhenium.

Where the catalyst includes two or more metals, one metal may act as a promoter metal and the other metal is the main metal. For instance, with a platinum/tin catalyst, platinum may be considered to be the main metal and tin may be considered the promoter metal. For convenience, the present specification refers to the first metal as the primary catalyst and the second metal (and optional metals) as the promoter(s). This should not be taken as an indication of the underlying mechanism of the catalytic activity.

In the first embodiment, when the catalyst includes two or more metals, e.g., a first metal and a second metal, the first metal optionally is present in the catalyst in an amount from 1 to 10 wt. %, e.g., from 1.2 to 5 wt. %, or from 1.5 to 3 wt. %. The second metal optionally is present in an amount from 0.1 and 20 wt. %, e.g., from 0.1 to 10 wt. %, or from 0.1 to 5 wt. %. For catalysts comprising two or more metals, the two or more metals may be alloyed with one another or may comprise a non-alloyed metal solution or mixture.

The preferred metal ratios may vary somewhat depending on the metals used in the catalyst. In some embodiments, the mole ratio of the first metal to the second metal is from 10:1 to 1:10, e.g., from 4:1 to 1:4, from 2:1 to 1:2, from 1.5:1 to 1:1.5 or from 1.1:1 to 1:1.1.

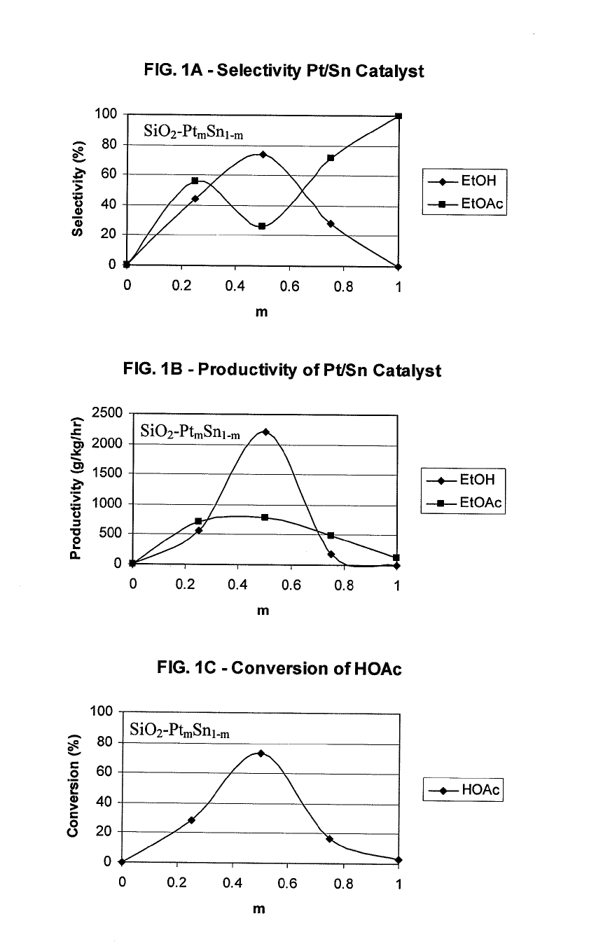

Molar ratios other than 1:1 may be preferred depending on the composition of the catalyst employed. It has now surprisingly and unexpectedly been discovered, for example, that for platinum/tin catalysts, platinum to tin molar ratios less than 0.4:0.6, or greater than 0.6:0.4 are particularly preferred in order to form ethyl acetate from acetic acid at high selectivity, conversion and productivity, as shown in FIGS. 1A, 1B and 1C. More preferably, the Pt/Sn ratio is greater than 0.65:0.35 or greater than 0.7:0.3, e.g., from 0.65:0.35 to 1:0 or from 0.7:0.3 to 1:0. Selectivity to ethyl acetate may be further improved by incorporating modified supports as described herein.

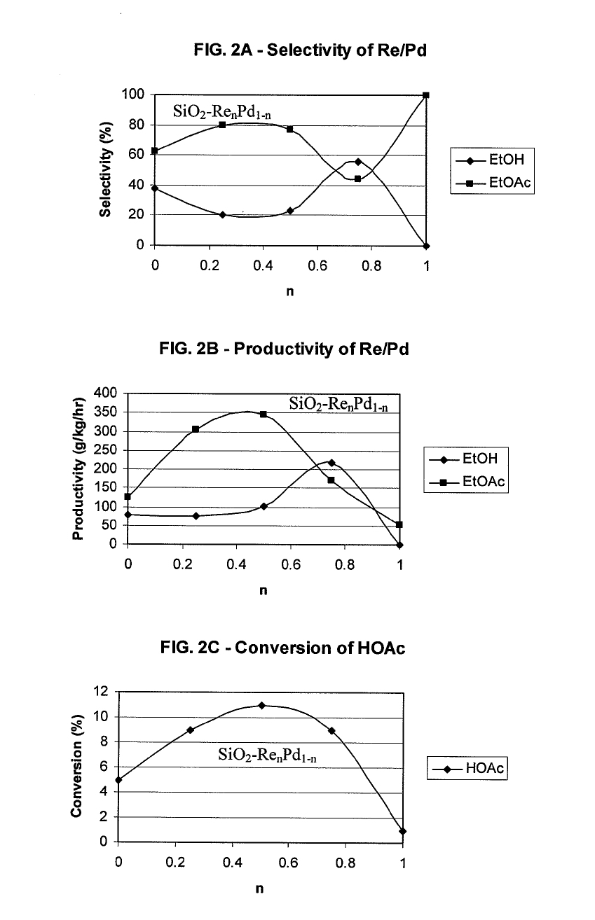

With rhenium/palladium catalysts, as shown in FIGS. 2A, 2B and 2C, preferred rhenium to palladium molar ratios for forming ethyl acetate in terms of selectivity, conversion and production are less than 0.7:0.3 or greater than 0.85:0.15. A preferred Re/Pd ratio for producing ethyl acetate in the presence of a Re/Pd catalyst is from 0.2:0.8 to 0.4:0.6. Again, selectivity to ethyl acetate may be further improved by incorporating modified supports as described herein.

In embodiments when the catalyst comprises a third metal, the third metal may be selected from any of the metals listed above in connection with the first or second metal, so long as the third metal is different from the first and second metals. In preferred aspects, the third metal is selected from the group consisting of cobalt, palladium, ruthenium, copper, zinc, platinum, tin, and rhenium. More preferably, the third metal is selected from cobalt, palladium, and ruthenium. When the third metal is present, the catalyst composition preferably comprises the third metal in an amount from 0.05 and 4 wt. %, e.g., from 0.1 to 3 wt. %, or from 0.1 to 2 wt. %.

In addition to the metal, the catalysts of the first embodiment further comprise a support, optionally a modified support. As will be appreciated by those of ordinary skill in the art, support materials are selected such that the catalyst system is suitably active, selective and robust under the process conditions employed for the formation of ethyl acetate or a mixture of ethyl acetate and ethanol. Suitable support materials may include, for example, stable metal oxide-based supports or ceramic-based supports as well as molecular sieves, such as zeolites. Examples of suitable support materials include without limitation, iron oxide, silica, alumina, silica/aluminas, titania, zirconia, magnesium oxide, calcium silicate, carbon, graphite, high surface area graphitized carbon, activated carbons, and mixtures thereof. Exemplary preferred supports are selected from the group consisting of silica/aluminas, titania, and zirconia. The total weight of the support in the catalyst, based on the total weight of the catalyst, preferably is from 25 wt % to 99 wt %, e.g., from 30 wt % to 98.5 wt %, or from 35 wt % to 98 wt %.

A preferred silica/alumina support material is KA-160 (Sud Chemie) silica spheres having a nominal diameter of about 5 mm, a density of about 0.562 g/ml, in absorptivity of about 0.583 g H₂O/g support, a surface area of about 160 to 175 m²/g, and a pore volume of about 0.68 ml/g.

In one embodiment, the support material comprises a silicaceous support material selected from the group consisting of silica, silica/alumina, a Group IIA silicate such as calcium metasilicate, pyrogenic silica, high purity silica and mixtures thereof. In one embodiment silica may be used as the silicaceous support, it is beneficial to ensure that the amount of aluminum, which is a common contaminant for silica, may be low, preferably under 1 wt. %, e.g., under 0.5 wt. % or under 0.3 wt. %, based on the total weight of the support. In this regard, pyrogenic silica is preferred as it commonly is available in purities exceeding 99.7 wt. %. High purity silica, as used throughout the application, refers to silica in which acidic contaminants such as aluminum are present, if at all, at levels of less than 0.3 wt. %, e.g., less than 0.2 wt. % or less than 0.1 wt. %.

The surface area of the support may vary widely depending on the type of support. In some aspects, the surface area of the support material, e.g., silicaceous material, may be at least about 50 m²/g, e.g., at least about 100 m²/g, at least about 150 m²/g, at least about 200 m²/g or most preferably at least about 250 m²/g. In terms of ranges, the support material preferably has a surface area of from 50 to 600 m²/g, e.g., from 100 to 500 m²/g or from 100 to 300 m²/g. High surface area silica, as used throughout the application, refers to silica having a surface area of at least about 250 m²/g. High surface area silica/alumina, as used throughout the application, refers to silica/alumina having a surface area of at least about 150 m²/g. For purposes of the present specification, surface area refers to BET nitrogen surface area, meaning the surface area as determined by ASTM D6556-04, the entirety of which is incorporated herein by reference.

The support material, e.g., silicaceous material, also preferably has an average pore diameter of from 5 to 100 nm, e.g., from 5 to 30 nm, from 5 to 25 nm or from about 5 to 10 nm, as determined by mercury intrusion porosimetry, and an average pore volume of from 0.5 to 2.0 cm³/g, e.g., from 0.7 to 1.5 cm³/g or from about 0.8 to 1.3 cm³/g, as determined by mercury intrusion porosimetry.

The morphology of the support material, and hence of the resulting catalyst composition, may vary widely. In some exemplary embodiments, the morphology of the support material and/or of the catalyst composition may be pellets, extrudates, spheres, spray dried microspheres, rings, pentarings, trilobes, quadrilobes, multi-lobal shapes, or flakes although cylindrical pellets are preferred. Preferably, the support material, e.g., silicaceous material, has a morphology that allows for a packing density of from 0.1 to 1.0 g/cm³, e.g., from 0.2 to 0.9 g/cm³ or from 0.5 to 0.8 g/cm³. In terms of size, the support material, e.g. silicaceous material, preferably has an average particle size, meaning the diameter for spherical particles or equivalent spherical diameter for non-spherical particles, of from 0.01 to 1.0 cm, e.g., from 0.1 to 0.5 cm or from 0.2 to 0.4 cm. Since the one or more metal(s) that are disposed on or within the modified support are generally very small in size, they should not substantially impact the size of the overall catalyst particles. Thus, the above particle sizes generally apply to both the size of the modified supports as well as to the final catalyst particles.

A preferred silica support material is SS61138 High Surface Area (HSA) Silica Catalyst Carrier from Saint Gobain N or Pro. The Saint-Gobain N or Pro SS61138 silica contains approximately 95 wt % high surface area silica; a surface area of about 250 m²/g; a median pore diameter of about 12 nm; a total pore volume of about 1.0 cm³/g as measured by mercury intrusion porosimetry and a packing density of about 0.352 g/cm³ (22 lb/ft³).

The supports for the first embodiment may further comprise a support modifier. A support modifier is added to the support and is not naturally present in the support. A support modifier adjusts effects of the acidity of the support material. The acid sites, e.g. Brønsted acid sites, on the support material may be adjusted by the support modifier, for example, to favor selectivity to ethyl acetate and mixtures of ethyl acetate during the hydrogenation of acetic acid. Unless the context indicates otherwise, the acidity of a surface or the number of acid sites thereupon may be determined by the technique described in F. Delannay, Ed., “Characterization of Heterogeneous Catalysts”; Chapter III: Measurement of Acidity of Surfaces, p. 370-404; Marcel Dekker, Inc., N.Y. 1984, the entirety of which is incorporated herein by reference.

In some aspects, the support material may be undesirably too acidic for formation of ethyl acetate at high selectivity. In this case, the support material may be modified with a basic support modifier. Suitable basic support modifiers may be selected, for example, from the group consisting of: (i) alkaline earth oxides, (ii) alkali metal oxides, (iii) alkaline earth metal metasilicates, (iv) alkali metal metasilicates, (v) Group IIB metal oxides, (vi) Group IIB metal metasilicates, (vii) Group IIIB metal oxides, (viii) Group IIIB metal metasilicates, and mixtures thereof. In addition to oxides and metasilicates, other types of modifiers including nitrates, nitrites, acetates, and lactates may be used in embodiments of the present invention. Preferably, the basic modifiers have a low volatility or are non-volatile. Low volatility modifiers have a rate of loss that is low enough such that the acidity of the support modifier is not reversed during the life of the catalyst. For example, the support modifier may be selected from the group consisting of oxides and metasilicates of any of sodium, potassium, magnesium, calcium, scandium, yttrium, and zinc, and mixtures of any of the foregoing. A particularly preferred basic support modifier is calcium metasilicate (CaSiO₃).

In some aspects, the support material is too basic or is not acidic enough for formation of ethyl acetate at high selectivity. In this case, the support may be modified with a support modifier that adjusts the support material by increasing the number or availability of acid sites by using a redox support modifier or an acidic support modifier. Suitable redox and acidic support modifiers may be selected from the group consisting of: oxides of Group IVB metals, oxides of Group VB metals, oxides of Group VIB metals, iron oxides, aluminum oxides, and mixtures thereof. These support modifiers are redox or acid non-volatile support modifiers. Preferred redox support modifiers include those selected from the group consisting of WO₃, MoO₃, Fe₂O₃, and Cr₂O₃. Preferred acidic support modifiers include those selected from the group consisting of TiO₂, ZrO₂, Nb₂O₅, Ta₂O₅, and Al₂O₃. Without being bound by theory, it is believed that an increase in acidity of the support may favor ethyl acetate formation. However, increasing acidity of the support may also form ethers and basic modifiers may be added to counteract the acidity of the support.

### Catalysts Comprising Nickel or Palladium and Tin or Zinc

In a second embodiment of the present invention, the invention is to a catalyst for making ethyl acetate or optionally a mixture of ethyl acetate and ethanol, the catalyst comprising a first metal selected from the group consisting of nickel and palladium, a second metal selected from the group consisting of tin and zinc, and a support, optionally a modified support. In contrast to the above-described first embodiment, in the second embodiment, lower loadings of the first metal may be employed. For example, the catalyst may comprise the first metal in an amount from 0.1 to 10 wt. %, e.g., from 0.1 to 5 wt. %, or from 0.1 to 3 wt. %. The second metal preferably is present in an amount from 0.1 and 20 wt. %, e.g., from 0.1 to 10 wt. %, or from 0.1 to 5 wt. %. The mole ratio of the first metal to the second metal preferably is from 10:1 to 1:10, e.g., from 4:1 to 1:4, from 2:1 to 1:2, from 1.5:1 to 1:1.5 or from 1.1:1 to 1:1.1. Optionally, the catalyst of the second embodiment may further comprise a third metal as described above in connection with the first embodiment.

In the second embodiment, the catalyst includes a support, optionally a modified support, as discussed above in connection with the first embodiment. The total weight of the support, based on the total weight of the catalyst, for the second embodiment preferably is from 25 wt. % to 99.9 wt. %, e.g., from 30 wt. % to 97 wt. %, or from 35 wt. % to 95 wt. %.

### Catalyst on Acidic or Redox Modified Support

In a third embodiment of the invention, the catalyst comprises a first metal and optionally one or more of a second metal, a third metal or additional metals, on a support that has been modified with a redox support modifier or an acidic support modifier. The total weight of all metals present in the catalyst preferably is from 0.1 to 25 wt. %, e.g., from 0.1 to 15 wt. %, or from 0.1 1 to 10 wt. %.

The first metal may be a Group IB, IIB, IIIB, IVB, VB, VIIB, VIIB, or VIII transitional metal, a lanthanide metal, an actinide metal or a metal from any of Groups IIIA, IVA, VA, or VIA. In a preferred embodiment, the first metal is selected the group consisting of copper, iron, cobalt, nickel, ruthenium, rhodium, palladium, osmium, iridium, platinum, titanium, zinc, chromium, rhenium, molybdenum, and tungsten. Preferably, the first metal is selected from the group consisting of platinum, palladium, cobalt, nickel, and ruthenium. More preferably, the first metal is selected from platinum and palladium. When the first metal comprises platinum, it is preferred that the catalyst comprises the platinum in an amount less than 5 wt %, e.g. less than 3 wt % or less than 1 wt %, due to the limited availability of platinum.

The catalyst optionally further comprises a second metal selected from the group consisting of copper, molybdenum, tin, chromium, iron, cobalt, vanadium, tungsten, palladium, platinum, lanthanum, cerium, manganese, ruthenium, rhenium, gold, and nickel. More preferably, the second metal is selected from the group consisting of copper, tin, cobalt, rhenium, and nickel. More preferably, the second metal is selected from tin and rhenium.

If the catalyst includes two or more metals, e.g., a first metal and a second metal, the first metal optionally is present in the catalyst in an amount from 0.1 to 10 wt. %, e.g. from 0.1 to 5 wt. %, or from 0.1 to 3 wt. %. The second metal preferably is present in an amount from 0.1 and 20 wt. %, e.g., from 0.1 to 10 wt. %, or from 0.1 to 5 wt. %. For catalysts comprising two or more metals, the two or more metals may be alloyed with one another or may comprise a non-alloyed metal solution or mixture.

As stated above in the first embodiment, in the third embodiment the preferred metal ratios may vary somewhat depending on the metals used in the catalyst. In some embodiments, the mole ratio of the first metal to the second metal preferably is from 10:1 to 1:10, e.g., from 4:1 to 1:4, from 2:1 to 1:2, from 1.5:1 to 1:1.5 or from 1.1:1 to 1:1.1.

Molar ratios other than 1:1 may be preferred for other catalysts. It has now surprisingly and unexpectedly been discovered, for example, that for platinum/tin catalysts, platinum to tin molar ratios less than 0.4:0.6, or greater than 0.6:0.4 are particularly preferred in order to form ethyl acetate from acetic acid at high selectivity, conversion and productivity, as shown in FIGS. 1A, 1B and 1C. A preferred Pt/Sn molar ratio for producing ethyl acetate in the presence of a Pt/Sn catalyst is from 0.65:0.35 to 0.95:0.05, e.g., from 0.7:0.3 to 0.95:0.05. Selectivity to ethyl acetate may be further improved by incorporating modified supports as described throughout the present specification.

With rhenium/palladium catalysts, as shown in FIGS. 2A, 2B and 2C, preferred rhenium to palladium molar ratios for forming ethyl acetate in terms of selectivity, conversion and production are less than 0.7:0.3 or greater than 0.85:0.15. A preferred Re/Pd molar ratio for producing ethyl acetate in the presence of a Re/Pd catalyst is from 0.2:0.8 to 0.4:0.6. Again, selectivity to ethyl acetate may be further improved by incorporating modified supports as described throughout the present specification.

In embodiments when the catalyst comprises a third metal, the third metal may be selected from any of the metals listed above in connection with the first or second metal, so long as the third metal is different from the first and second metals. In preferred aspects, the third metal is selected from the group consisting of cobalt, palladium, ruthenium, copper, zinc, platinum, tin, and rhenium. More preferably, the third metal is selected from cobalt, palladium, and ruthenium. When present, the total weight of the third metal preferably is from 0.05 and 4 wt. %, e.g., from 0.1 to 3 wt. %, or from 0.1 to 2 wt. %.

In one embodiment, the catalyst comprises a first metal and no additional metals (no second metal, etc.). In this embodiment, the first metal preferably is present in an amount from 0.1 to 10 wt. %. In another embodiment, the catalyst comprises a combination of two or more metals on a support. Specific preferred metal compositions for various catalysts of this embodiment of the invention are provided below in Table 1. Where the catalyst comprises a first metal and a second metal, the first metal preferably is present in an amount from 0.1 to 5 wt. % and the second metal preferably is present in an amount from 0.1 to 5 wt. %. Where the catalyst comprises a first metal, a second metal and a third metal, the first metal preferably is present in an amount from 0.1 to 5 wt. %, the second metal preferably is present in an amount from 0.1 to 5 wt. %, and the third metal preferably is present in an amount from 0.1 to 2 wt. %. Where the first metal is platinum, the first metal preferably is present in an amount from 0.1 to 3 wt. %, the second metal is present in an amount from 0.1 to 5 wt. %, and the third metal, if present, preferably is present in an amount from 0.1 to 2 wt. %.

TABLE 1
EXEMPLARY METAL COMBINATIONS FOR CATALYSTS

| First Metal | Second Metal | Third Metal |
|---|---|---|
| Cu | Ag | |
| Cu | Cr | |
| Cu | V | |
| Cu | W | |
| Cu | Zn | |
| Ni | Au | |
| Ni | Re | |
| Ni | V | |
| Ni | W | |
| Ni | Zn | |
| Ni | Sn | |
| Pd | Zn | |
| Pd | Co | |
| Pd | Cr | |
| Pd | Cu | |
| Pd | Fe | |
| Pd | La | |
| Pd | Mo | |
| Pd | Ni | |
| Pd | Re | |
| Pd | Sn | |
| Pd | V | |
| Pd | W | |
| Pt | Co | |
| Pt | Cr | |
| Pt | Cu | |
| Pt | Fe | |
| Pt | Mo | |
| Pt | Sn | |
| Pt | Sn | Co |
| Pt | Sn | Re |
| Pt | Sn | Ru |
| Pt | Sn | Pd |
| Rh | Cu | |
| Rh | Ni | |
| Ru | Co | |
| Ru | Cr | |
| Ru | Cu | |
| Ru | Fe | |
| Ru | La | |
| Ru | Mo | |
| Ru | Ni | |
| Ru | Sn | |

Depending primarily on how the catalyst is manufactured, the metals of the catalysts of the present invention may be dispersed throughout the support, coated on the outer surface of the support (egg shell) or decorated on the surface of the support.

In addition to one or more metals, the catalysts of the third embodiment of the present invention further comprise a modified support, meaning a support that includes a support material and a support modifier. In particular, the use of acidic or redox modified supports surprisingly and unexpectedly has now been demonstrated to favor formation of ethyl acetate over other hydrogenation products.

Examples of suitable support materials include those stated above in connection with the first embodiment and without limitation include iron oxide, silica, alumina, silica/aluminas, titania, zirconia, magnesium oxide, calcium silicate, carbon, graphite, high surface area graphitized carbon, activated carbons, and mixtures thereof. The support further comprises a support modifier that, for example, may be selected from the group consisting of: oxides of Group IVB metals, oxides of Group VB metals, oxides of Group VIB metals, iron oxides, aluminum oxides, and mixtures thereof. These support modifiers are redox or acidic support modifiers. Preferred redox support modifiers include those selected from the group consisting of WO₃, MoO₃, Fe₂O₃, and Cr₂O₃. Preferred acidic support modifiers include those selected from the group consisting of TiO₂, ZrO₂, Nb₂O₅, Ta₂O₅, and Al₂O₃. Preferably, the support comprises a support modifier that is an acidic or redox modifier having a low volatility or is non-volatile. Low volatility modifiers have a rate of loss that is low enough such that the acidity of the support modifier is not reversed during the life of the catalyst. As indicated above, the support modifier is added to the support and is not naturally present in the support.

The total weight of the modified support, including the support material and the support modifier, based on the total weight of the catalyst, preferably is from 25 wt. % to 99.9 wt. %, e.g., from 30 wt. % to 97 wt. %, or from 35 wt % to 95 wt. %. The support modifier preferably is provided in an amount sufficient to increase the number of active Brønsted acid sites or availability of those acid sites. In preferred embodiments, the support modifier is present in an amount from 0.1 wt. % to 50 wt. %, e.g., from 0.2 wt. % to 25 wt. %, from 0.5 wt. % to 15 wt. %, or from 1 wt. % to 8 wt. %, based on the total weight of the catalyst. In preferred embodiments, the support material is present in an amount from 25 wt. % to 99 wt. %, e.g., from 30 wt. % to 97 wt. % or from 35 wt. % to 95 wt. %.

If desired, the acidic or redox support modifiers described herein in connection with the third embodiment of the invention may also be used to modify the supports of the above-described first embodiment or the second embodiment.

Catalysts of the present invention are particulate catalysts in the sense that, rather than being impregnated in a wash coat onto a monolithic carrier similar to automotive catalysts and diesel soot trap devices, the catalysts of the invention preferably are formed into particles, sometimes also referred to as beads or pellets, having any of a variety of shapes and the catalytic metals are provided to the reaction zone by placing a large number of these shaped catalysts in the reactor. Commonly encountered shapes include extrudates of arbitrary cross-section taking the form of a generalized cylinder in the sense that the generators defining the surface of the extrudate are parallel lines. As indicated above, any convenient particle shape including pellets, extrudates, spheres, spray dried microspheres, rings, pentarings, trilobes, quadrilobes and multi-lobal shapes may be used, although cylindrical pellets are preferred. Typically, the shapes are chosen empirically based upon perceived ability to contact the vapor phase with the catalytic agents effectively.

One advantage of catalysts of the present invention, in all of the above embodiments, is the stability or activity of the catalyst for producing ethyl acetate and mixtures of ethyl acetate and ethanol. Accordingly, it can be appreciated that the catalysts of the present invention are fully capable of being used in commercial scale industrial applications for the hydrogenation of acetic acid, particularly in the production of ethyl acetate. In particular, it is possible to achieve such a degree of stability such that catalyst activity will have rate of productivity decline that is less than 6% per 100 hours of catalyst usage, e.g., less than 3% per 100 hours or less than 1.5% per 100 hours. Preferably, the rate of productivity decline is determined once the catalyst has achieved steady-state conditions.

### Processes for Making the Catalysts

The catalyst compositions of the first, second and third embodiments of the present invention preferably are formed through metal impregnation of the support and/or modified supports, although other processes such as chemical vapor deposition may also be employed. Before the metals are impregnated, it typically is desired to form the modified support, if necessary, through a step of impregnating the support material with the support modifier. In one aspect, the support modifier, e.g., WO₃ or TiO₂, or a precursor to the support modifier is added to the support material in an aqueous suspension. For example, an aqueous suspension of the support modifier may be formed by adding the solid support modifier to deionized water, followed by the addition of colloidal support material thereto. The resulting mixture may be stirred and added to additional support material using, for example, incipient wetness techniques in which the support modifier is added to a support material having the same pore volume as the volume of the support modifier solution. Capillary action then draws the support modifier into the pores in the support material. The modified support can then be formed by drying and calcining to drive off water and any volatile components within the support modifier solution and depositing the support modifier on the support material. Drying may occur, for example, at a temperature of from 50° C. to 300° C., e.g., from 100° C. to 200° C. or about 120° C., optionally for a period of from 1 to 24 hours, e.g., from 3 to 15 hours or from 6 to 12 hours. Once formed, the modified supports may be shaped into particles having the desired size distribution, e.g., to form particles having an average particle size in the range of from 0.2 to 0.4 cm. The supports may be extruded, pelletized, tabletized, pressed, crushed or sieved to the desired size distribution. Any of the known methods to shape the support materials into desired size distribution can be employed. Calcining of the shaped modified support may occur, for example, at a temperature of from 250° C. to 800° C., e.g., from 300 to 700° C. or about 500° C., optionally for a period of from 1 to 12 hours, e.g., from 2 to 10 hours, from 4 to 8 hours or about 6 hours.

In a preferred method of preparing the catalyst, the metals are impregnated onto the support or modified support. A precursor of the first metal (first metal precursor) preferably is used in the metal impregnation step, such as a water soluble compound or water dispersible compound/complex that includes the first metal of interest. Depending on the metal precursor employed, the use of a solvent, such as water, glacial acetic acid or an organic solvent, may be preferred. The second metal also preferably is impregnated into the support or modified support from a second metal precursor. If desired, a third metal or third metal precursor may also be impregnated into the support or modified support.

Impregnation occurs by adding, optionally drop wise, either or both the first metal precursor and/or the second metal precursor and/or additional metal precursors, preferably in suspension or solution, to the dry support or modified support. The resulting mixture may then be heated, e.g., optionally under vacuum, in order to remove the solvent. Additional drying and calcining may then be performed, optionally with ramped heating to form the final catalyst composition. Upon heating and/or the application of vacuum, the metal(s) of the metal precursor(s) preferably decompose into their elemental (or oxide) form. In some cases, the completion of removal of the liquid carrier, e.g., water, may not take place until the catalyst is placed into use and calcined, e.g., subjected to the high temperatures encountered during operation. During the calcination step, or at least during the initial phase of use of the catalyst, such compounds are converted into a catalytically active form of the metal or a catalytically active oxide thereof.

Impregnation of the first and second metals (and optional additional metals) into the support or modified support may occur simultaneously (co-impregnation) or sequentially. In simultaneous impregnation, the first and second metal precursors (and optionally additional metal precursors) are mixed together and added to the support or modified support together, followed by drying and calcination to form the final catalyst composition. With simultaneous impregnation, it may be desired to employ a dispersion agent, surfactant, or solubilizing agent, e.g., ammonium oxalate, to facilitate the dispersing or solubilizing of the first and second metal precursors in the event the either or both precursors are incompatible with the desired solvent, e.g., water.

In sequential impregnation, the first metal precursor is first added to the support or modified support followed by drying and calcining, and the resulting material is then impregnated with the second metal precursor followed by an additional drying and calcining step to form the final catalyst composition. Additional metal precursors (e.g., a third metal precursor) may be added either with the first and/or second metal precursor or a separate third impregnation step, followed by drying and calcination. Of course, combinations of sequential and simultaneous impregnation may be employed if desired.

Suitable metal precursors include, for example, metal halides, amine solubilized metal hydroxides, metal nitrates or metal oxalates of the desired metal(s). For example, suitable compounds for platinum precursors and palladium precursors include chloroplatinic acid, ammonium chloroplatinate, amine solubilized platinum hydroxide, platinum nitrate, platinum tetra ammonium nitrate, platinum chloride, platinum oxalate, palladium nitrate, palladium tetra ammonium nitrate, palladium chloride, palladium oxalate, sodium palladium chloride, and sodium platinum chloride. Generally, both from the point of view of economics and environmental aspects, aqueous solutions of soluble compounds of platinum are preferred. In one embodiment, the first metal precursor is not a metal halide and is substantially free of metal halides.

In one aspect, the “promoter” metal or metal precursor is first added to the modified support, followed by the “main” or “primary” metal or metal precursor. Of course, the reverse order of addition is also possible. Exemplary precursors for promoter metals include metal halides, amine solubilized metal hydroxides, metal nitrates or metal oxalates. As indicated above, in the sequential embodiment, each impregnation step preferably is followed by drying and calcination. In the case of promoted bimetallic catalysts as described above, a sequential impregnation may be used, starting with the addition of the promoter metal followed by a second impregnation step involving co-impregnation of the two principal metals, e.g., Pt and Sn.

### Hydrogenation of Acetic Acid

The process of hydrogenating acetic acid to form ethyl acetate or a mixture of ethyl acetate and ethanol according to one embodiment of the invention may be conducted in a variety of configurations using a fixed bed reactor or a fluidized bed reactor as one of skill in the art will readily appreciate using catalysts of the first, second or third embodiments. In many embodiments of the present invention, an “adiabatic” reactor can be used; that is, there is little or no need for internal plumbing through the reaction zone to add or remove heat. Alternatively, a shell and tube reactor provided with a heat transfer medium can be used. In many cases, the reaction zone may be housed in a single vessel or in a series of vessels with heat exchangers therebetween. It is considered significant that acetic acid reduction processes using the catalysts of the present invention may be carried out in adiabatic reactors as this reactor configuration is typically far less capital intensive than tube and shell configurations.

Typically, the catalyst is employed in a fixed bed reactor, e.g., in the shape of an elongated pipe or tube where the reactants, typically in the vapor form, are passed over or through the catalyst. Other reactors, such as fluid or ebullient bed reactors, can be employed, if desired. In some instances, the hydrogenation catalysts may be used in conjunction with an inert material to regulate the pressure drop of the reactant stream through the catalyst bed and the contact time of the reactant compounds with the catalyst particles.

The hydrogenation reaction may be carried out in either the liquid phase or vapor phase. Preferably the reaction is carried out in the vapor phase under the following conditions. The reaction temperature may the range from of 125° C. to 350° C., e.g., from 200° C. to 325° C., from 225° C. to about 300° C., or from 250° C. to about 300° C. The pressure may range from 10 KPa to 3000 KPa (about 0.1 to 30 atmospheres), e.g., from 50 KPa to 2300 KPa, or from 100 KPa to 1500 KPa. The reactants may be fed to the reactor at a gas hourly space velocities (GHSV) of greater than 500 hr⁻¹, e.g., greater than 1000 hr⁻¹, greater than 2500 hr⁻¹ and even greater than 5000 hr⁻¹. In terms of ranges the GHSV may range from 50 hr⁻¹ to 50,000 hr⁻¹, e.g., from 500 hr⁻¹ to 30,000 hr⁻¹, from 1000 hr⁻¹ to 10,000 hr⁻¹, or from 1000 hr⁻¹ to 6500 hr⁻¹.

In another aspect of the process of this invention, the hydrogenation is carried out at a pressure just sufficient to overcome the pressure drop across the catalytic bed at a suitable GHSV, although there is no bar to the use of higher pressures, it being understood that considerable pressure drop through the reactor bed may be experienced at high space velocities, e.g., on the order of 5000 or 6,500 hr⁻¹.

Although the reaction consumes two moles of hydrogen for every two moles of acetic acid to produce one mole of ethyl acetate, the actual molar ratio of hydrogen to acetic acid in the feed stream may vary from about 100:1 to 1:100, e.g., from 50:1 to 1:50, from 20:1 to 1:2, or from 12:1 to 1:1. Most preferably, the molar ratio of hydrogen to acetic acid is greater than 4:1, e.g., greater than 5:1 or greater than 10:1.

Contact or residence time can also vary widely, depending upon such variables as amount of acetic acid, catalyst, reactor, temperature and pressure. Typical contact times range from a fraction of a second to more than several hours when a catalyst system other than a fixed bed is used, with preferred contact times, at least for vapor phase reactions, from 0.1 to 100 seconds, e.g., from 0.3 to 80 seconds or from 0.4 to 30 seconds.

The acetic acid may be vaporized at the reaction temperature, and then the vaporized acetic acid can be fed along with hydrogen in undiluted state or diluted with a relatively inert carrier gas, such as nitrogen, argon, helium, carbon dioxide and the like. For reactions run in the vapor phase, the temperature should be controlled in the system such that it does not fall below the dew point of acetic acid.

In particular, the catalysts and processes of the present invention may achieve favorable conversion of acetic acid and favorable selectivity and productivity to ethyl acetate or mixtures of ethyl acetate and ethanol. For purposes of the present invention, the term conversion refers to the amount of acetic acid in the feed that is convert to a compound other than acetic acid. Conversion is expressed as a mole percentage based on acetic acid in the feed. The conversion of acetic acid (AcOH) is calculated from gas chromatography (GC) data using the following equation:

$$AcOH Conv . ( \% ) = 100 ⋆ \frac{\begin{matrix}mmol AcOH ( feed stream ) - \\ mmol AcOH ( GC )\end{matrix}}{mmol AcOH ( feed stream )}$$

For purposes of the present invention, the conversion may be at least 10%, e.g., at least 20%, at least 40%, at least 50%, at least 60%, or at least 70% or at least 80%. Although catalysts that have high conversions are desirable, such as at least 80% or at least 90%, a low conversion may be acceptable at high selectivity for ethyl acetate or mixtures of ethyl acetate and ethanol. It is, of course, well understood that in many cases, it is possible to compensate for conversion by appropriate recycle streams or use of larger reactors, but it is more difficult to compensate for poor selectivity.

“Selectivity” is expressed as a mole percent based on converted acetic acid. It should be understood that each compound converted from acetic acid has an independent selectivity and that selectivity is independent from conversion. For example, if 50 mole % of the converted acetic acid is converted to ethyl acetate, we refer to the ethyl acetate selectivity as 50%. Selectivity to ethyl acetate (EtOAc) and mixtures of EtOAc and ethanol (EtOH) is calculated from gas chromatography (GC) data using the following equation:

$$EtOAc Sel . ( \% ) = 100 ⋆ \frac{mmol EtOAc ( GC )}{\begin{matrix}\frac{Total mmol C ( GC )}{2} - \\ mmol AcOH ( feed stream )\end{matrix}}$$

wherein “Total mmol C (GC)” refers to total mmols of carbon from all of the products analyzed by gas chromatograph.

For purposes of the present invention, the selectivity to ethoxylates of the catalyst is at least 60%, e.g., at least 70%, or at least 80%. As used herein, “ethoxylates” refers converted compounds that have at least two carbon atoms, such as ethanol, acetaldehyde, ethyl acetate, etc., but excludes ethane. Preferably, the selectivity to ethyl acetate is at least 40%, e.g., at least 50% or at least 60%.

Preferably, the selectivity to mixtures of ethyl acetate and ethanol is at least 50%, e.g., at least 60% or at least 70%. In one embodiment of the present invention, it is preferred that ethyl acetate comprises at a major component of the product mixture, e.g., at least 50 wt %, e.g. from at least 55 wt % or from at least 60 wt %. In addition to ethyl acetate, ethanol also may be formed, for example, at selectivities of at least 20%, e.g. least 30% or at least 40%. In another embodiment of the present invention, the process forms ethanol as a major component, e.g., in an amount greater than 50 wt %, e.g., at least 55 wt % or at least 60 wt %. In this aspect, ethyl acetate may be also be formed, for example, at a selectivities of at least 20%, e.g. at least 30% or at least 40%. It should be understood that in such mixtures, if desired, either the ethyl acetate may be further reacted to form more ethanol, or the ethanol may be further reacted to form more ethyl acetate.

In embodiments of the present invention, it is also desirable to have low selectivity to undesirable products, such as methane, ethane, and carbon dioxide. The selectivity to these undesirable products preferably should be less than 4%, e.g., less than 2% or less than 1%. Preferably, no detectable amounts of these undesirable products are formed during hydrogenation. In several embodiments of the present invention, formation of alkanes is low, usually under 2%, often under 1%, and in many cases under 0.5% of the acetic acid passed over the catalyst is converted to alkanes, which have little value other than as fuel.

Productivity refers to the grams of a specified product, e.g., ethyl acetate, formed during the hydrogenation based on the kilogram of catalyst used per hour. In one embodiment, a productivity of at least 200 grams of ethyl acetate per kilogram catalyst per hour, e.g., at least 400 grams of ethyl acetate or least 600 grams of ethyl acetate, is preferred. In another embodiment, a productivity of at least 200 grams of a mixture of ethyl acetate and ethanol per kilogram catalyst per hour, e.g., at least 400 grams of a mixture of ethyl acetate and ethanol or least 600 grams of ethyl a mixture of ethyl acetate and ethanol, is preferred. In terms of ranges, the productivity preferably to ethyl acetate is from 200 to 3,000 grams of ethyl acetate per kilogram catalyst per hour, e.g., from 400 to 2,500 or from 600 to 2,000.

Some catalysts of the present invention may achieve a conversion of acetic acid of at least 10%, a selectivity to ethyl acetate of at least 60%, and a productivity of at least 200 g of ethyl acetate per kg of catalyst per hour. A subset of catalysts of the invention may achieve a conversion of acetic acid of at least 50%, a selectivity to ethyl acetate of at least 70%, a selectivity to undesirable compounds of less than 4%, and a productivity of at least 600 g of ethyl acetate per kg of catalyst per hour.

### Crude Ethyl Acetate Product

In another embodiment, the invention is to a crude ethyl acetate product formed by any of the processes of the present invention. The crude ethyl acetate product produced by the hydrogenation process of the present invention, before any subsequent processing, such as purification and separation, typically will comprise primarily unreacted acetic acid, ethyl acetate and optionally ethanol. In some exemplary embodiments, the crude product comprises ethyl acetate in an amount from 5 wt % to 70 wt. %, e.g., from 15 wt. % to 50 wt. %, or from 20 wt. % to 35 wt %, based on the total weight of the crude product. The crude product may comprise ethanol in an amount from 5 wt. % to 70 wt. %, e.g., from 15 wt % to 50 wt. %, or from 20 wt. % to 35 wt. %, based on the total weight of the crude product. The crude product typically will further comprise unreacted acetic acid, depending on conversion, for example, in an amount from 5 to 75 wt. %, e.g., from 10 to 60 wt. % or from 20 to 50 wt. %. Since water is formed in the reaction process, water will also be present in the crude product, for example, in amounts ranging from 5 to 50 wt. %, e.g., from 10 to 45 wt. % or from 15 to 35 wt. %. Other components, such as, for example, aldehydes, ketones, alkanes, and carbon dioxide, if detectable, collectively may be present in amounts less than 10 wt. %, e.g., less than 6 or less than 4 wt. %. In terms of ranges other components may be present in an amount from 0.1 to 10 wt. %, e.g., from 0.1 to 6 wt. %, or from 0.1 to 4 wt. %.

In a preferred embodiment, depending on the specific catalyst and process conditions employed, the crude ethyl acetate product may have any of the compositions indicated below in Table 2. Crude mixtures of ethyl acetate and ethanol may have any of the compositions indicated below in Table 3.

TABLE 2
CRUDE ETHYL ACETATE PRODUCT COMPOSITIONS

| | Conc. | Conc. | Conc. |
|---|---|---|---|
| Component | (wt. %) | (wt. %) | (wt. %) |
| Ethyl Acetate | 5-70 | 15-50 | 20-35 |
| Acetic Acid | 5-75 | 10-60 | 20-50 |
| Water | 5-50 | 10-45 | 15-35 |
| Other | <10 | <6 | <4 |

TABLE 3
CRUDE ETHYL ACETATE/ETHANOL
MIXTURE PRODUCT COMPOSITIONS

| | Conc. | Conc. | Conc. |
|---|---|---|---|
| Component | (wt. %) | (wt. %) | (wt. %) |
| Ethyl Acetate | 5-70 | 15-50 | 20-35 |
| Ethanol | 5-70 | 15-50 | 20-35 |
| Acetic Acid | 5-75 | 10-60 | 20-50 |
| Water | 5-50 | 10-45 | 15-35 |
| Other | <10 | <6 | <4 |

The raw materials used in connection with the process of this invention may be derived from any suitable source including natural gas, petroleum, coal, biomass and so forth. It is well known to produce acetic acid through methanol carbonylation, acetaldehyde oxidation, ethylene oxidation, oxidative fermentation, and anaerobic fermentation. As petroleum and natural gas prices fluctuate becoming either more or less expensive, methods for producing acetic acid and intermediates such as methanol and carbon monoxide from alternate carbon sources have drawn increasing interest. In particular, when petroleum is relatively expensive compared to natural gas, it may become advantageous to produce acetic acid from synthesis gas (“syn gas”) that is derived from any available carbon source. U.S. Pat. No. 6,232,352 to Vidalin, the disclosure of which is incorporated herein by reference, for example, teaches a method of retrofitting a methanol plant for the manufacture of acetic acid. By retrofitting a methanol plant, the large capital costs associated with CO generation for a new acetic acid plant are significantly reduced or largely eliminated. All or part of the syn gas is diverted from the methanol synthesis loop and supplied to a separator unit to recover CO and hydrogen, which are then used to produce acetic acid. In addition to acetic acid, the process can also be used to make hydrogen which may be utilized in connection with this invention.

United States Patent No. RE 35,377 to Steinberg et al., also incorporated herein by reference, provides a method for the production of methanol by conversion of carbonaceous materials such as oil, coal, natural gas and biomass materials. The process includes hydrogasification of solid and/or liquid carbonaceous materials to obtain a process gas which is steam pyrolized with additional natural gas to form synthesis gas. The syn gas is converted to methanol which may be carbonylated to acetic acid. The method likewise produces hydrogen which may be used in connection with this invention as noted above. See also, U.S. Pat. No. 5,821,111 to Grady et al., which discloses a process for converting waste biomass through gasification into synthesis gas as well as U.S. Pat. No. 6,685,754 to Kindig et al., the disclosures of which are incorporated herein by reference.

Alternatively, acetic acid in vapor form may be taken directly as crude product from the flash vessel of a methanol carbonylation unit of the class described in U.S. Pat. No. 6,657,078 to Scates et al., the entirety of which is incorporated herein by reference. The crude vapor product, for example, may be fed directly to the ethanol synthesis reaction zones of the present invention without the need for condensing the acetic acid and light ends or removing water, saving overall processing costs.

Ethyl acetate obtained by the present invention, may be used in its own right, polymerized, or converted to ethylene through a cracking process. The cracking of ethyl acetate to ethylene is shown below.

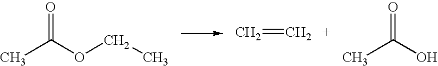

The cracking may be a catalyzed reaction utilizing a cracking catalyst. Suitable cracking catalysts include sulfonic acid resins such as perfluorosulfonic acid resins disclosed in U.S. Pat. No. 4,399,305, noted above, the disclosure of which is incorporated herein by reference. Zeolites are also suitable as cracking catalysts as noted in U.S. Pat. No. 4,620,050, the disclosure of which is also incorporated herein by reference.

Any ethanol in the mixtures of the present invention, may be used in its own right as a fuel or subsequently converted to ethylene which is an important commodity feedstock as it can be converted to polyethylene, vinyl acetate and/or ethyl acetate or any of a wide variety of other chemical products. For example, ethylene can also be converted to numerous polymer and monomer products. The dehydration of ethanol to ethylene is shown below.

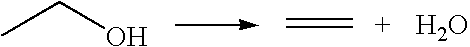

Any of known dehydration catalysts can be employed in to dehydrate ethanol, such as those described in copending applications U.S. application Ser. No. 12/221,137 and U.S. application Ser. No. 12/221,138, the entire contents and disclosures of which are hereby incorporated by reference. A zeolite catalyst, for example, may be employed as the dehydration catalyst. While any zeolite having a pore diameter of at least about 0.6 nm can be used, preferred zeolites include dehydration catalysts selected from the group consisting of mordenites, ZSM-5, a zeolite X and a zeolite Y. Zeolite X is described, for example, in U.S. Pat. No. 2,882,244 and zeolite Y in U.S. Pat. No. 3,130,007, the entireties of which are hereby incorporated by reference. A zeolite catalyst may be used to concurrently dehydrate ethanol to ethylene and decompose ethyl acetate to ethylene in a highly efficient process of the invention.

In embodiments where a mixture of ethyl acetate and ethanol is formed, it may be desired to further react the mixture in order to enrich the mixture in either the ethyl acetate or ethanol. For example, if desired, the ethanol concentration in the mixture may be increased through hydrolysis of the ethyl acetate in the presence of an acid catalyst to make additional ethanol and acetic acid. The acetic acid then may be recycled back in the hydrogenation process.

The following examples describe the procedures used for the preparation of various catalysts employed in the process of this invention.

### EXAMPLES

### Catalyst Preparations (General)

The catalyst supports were dried at 120° C. overnight under circulating air prior to use. All commercial supports (i.e., SiO₂, TiO₂) were used as a 14/30 mesh, or in its original shape ( 1/16 inch or ⅛ inch pellets) unless mentioned otherwise. Powdered materials were pelletized, crushed and sieved after the metals had been added. The individual catalyst preparations of the invention, as well as comparative examples, are described in detail below.

### Example 1

### SiO₂−CaSiO₃(5)-Pt(3)-Sn(1.8)

The catalyst was prepared by first adding CaSiO₃ (Aldrich) to the SiO₂ catalyst support, followed by the addition of Pt/Sn. First, an aqueous suspension of CaSiO₃ 200 mesh) was prepared by adding 0.52 g of the solid to 13 ml of deionized H₂O, followed by the addition of 1.0 ml of colloidal SiO₂ (15 wt % solution, NALCO). The suspension was stirred for 2 h at room temperature and then added to 10.0 g of SiO₂ catalyst support (14/30 mesh) using incipient wetness technique. After standing for 2 hours, the material was evaporated to dryness, followed by drying at 120° C. overnight under circulating air and calcination at 500° C. for 6 hours. All of the SiO₂−CaSiO₃ material was then used for Pt/Sn metal impregnation.

The catalysts were prepared by first adding Sn(OAc)₂ (tin acetate, Sn(OAc)₂ from Aldrich) (0.4104 g, 1.73 mmol) to a vial containing 6.75 ml of 1:1 diluted glacial acetic acid (Fisher). The mixture was stirred for 15 min at room temperature, and then, 0.6711 g (1.73 mmol) of solid Pt(NH₃)₄(NO₃)₂ (Aldrich) were added. The mixture was stirred for another 15 min at room temperature, and then added drop wise to 5.0 g of SiO₂−CaSiO₃ support, in a 100 ml round-bottomed flask. The metal solution was stirred continuously until all of the Pt/Sn mixture had been added to the SiO₂−CaSiO₃ support while rotating the flask after every addition of metal solution. After completing the addition of the metal solution, the flask containing the impregnated catalyst was left standing at room temperature for two hours. The flask was then attached to a rotor evaporator (bath temperature 80° C.), and evacuated until dried while slowly rotating the flask. The material was then dried further overnight at 120° C., and then calcined using the following temperature program: 25°→160° C./ramp 5.0 deg/min; hold for 2.0 hours; 160→500° C./ramp 2.0 deg/min; hold for 4 hours. Yield: 11.21 g of dark grey material.

### Example 2

### KA160-CaSiO₃(8)-Pt(3)-Sn(1.8)

The material was prepared by first adding CaSiO₃ to the KA160 catalyst support (SiO₂-(0.05) Al₂O₃, Sud Chemie, 14/30 mesh), followed by the addition of Pt/Sn. First, an aqueous suspension of CaSiO₃ (≦200 mesh) was prepared by adding 0.42 g of the solid to 3.85 ml of deionized H₂O, followed by the addition of 0.8 ml of colloidal SiO₂ (15 wt % solution, NALCO). The suspension was stirred for 2 h at room temperature and then added to 5.0 g of KA160 catalyst support (14/30 mesh) using incipient wetness technique. After standing for 2 hours, the material was evaporated to dryness, followed by drying at 120° C. overnight under circulating air and calcinations at 500° C. for 6 hours. All of the KA160-CaSiO₃ material was then used for Pt/Sn metal impregnation.

The catalysts were prepared by first adding Sn(OAc)₂ (tin acetate, Sn(OAc)₂ from Aldrich) (0.2040 g, 0.86 mmol) to a vial containing 6.75 ml of 1:1 diluted glacial acetic acid (Fisher). The mixture was stirred for 15 min at room temperature, and then, 0.3350 g (0.86 mmol) of solid Pt(NH₃)₄(NO₃)₂ (Aldrich) were added. The mixture was stirred for another 15 min at room temperature, and then added drop wise to 5.0 g of SiO2−CaSiO3 support, in a 100 ml round-bottomed flask. After completing the addition of the metal solution, the flask containing the impregnated catalyst was left standing at room temperature for two hours. The flask was then attached to a rotor evaporator (bath temperature 80° C.), and evacuated until dried while slowly rotating the flask. The material was then dried further overnight at 120° C., and then calcined using the following temperature program: 25°→160° C./ramp 5.0 deg/min; hold for 2.0 hours; 160→500° C./ramp 2.0 deg/min; hold for 4 hours. Yield: 5.19 g of tan-colored material.

### Example 3

### SiO₂−CaSiO₃(2.5)-Pt(1.5)-Sn(0.9).

This catalyst was prepared in the same manner as Example 1, with the following starting materials: 0.26 g of CaSiO₃ as a support modifier; 0.5 ml of colloidal SiO₂ (15 wt % solution, NALCO), 0.3355 g (0.86 mmol) of Pt(NH₃)₄(NO₃)₂; and 0.2052 g (0.86 mmol) of Sn(OAc)₂. Yield: 10.90 g of dark grey material.

### Example 4

### SiO₂+MgSiO₃—Pt(1.0)-Sn(1.0)

This catalyst was prepared in the same manner as Example 1, with the following starting materials: 0.69 g of Mg(AcO) as a support modifier; 1.3 g of colloidal SiO₂ (15 wt. % solution, NALCO), 0.2680 g (0.86 mmol) of Pt(NH₃)₄(NO₃)₂; and 0.1640 g (0.86 mmol) of Sn(OAc)₂. Yield: 8.35 g. The SiO₂ support is impregnated with a solution of Mg(AcO) and colloidal SiO₂. The support is dried and then calcined to 700° C.

### Example 5

### SiO₂−CaSiO₃(5)-Re(4.5)-Pd(1)

The SiO₂−CaSiO₃(5) modified catalyst support was prepared as described in Example 1. The Re/Pd catalyst was prepared then by impregnating the SiO₂−CaSiO₃(5) ( 1/16 inch extrudates) with an aqueous solution containing NH₄ReO₄ and Pd(NO₃)₂. The metal solutions were prepared by first adding NH₄ReO₄ (0.7237 g, 2.70 mmol) to a vial containing 12.0 ml of deionized H₂O. The mixture was stirred for 15 min at room temperature, and 0.1756 g (0.76 mmol) of solid Pd(NO₃)₂ was then added. The mixture was stirred for another 15 min at room temperature, and then added drop wise to 10.0 g of dry SiO₂-(0.05)CaSiO₃ catalyst support in a 100 ml round-bottomed flask. After completing the addition of the metal solution, the flask containing the impregnated catalyst was left standing at room temperature for two hours. All other manipulations (drying, calcination) were carried out as described in Example 1. Yield: 10.9 g of brown material.

### Example 6

### SiO₂−ZnO(5)-Pt(1)-Sn(1)

Powdered and meshed high surface area silica NPSG SS61138 (100 g) of uniform particle size distribution of about 0.2 mm was dried at 120° C. in a circulating air oven atmosphere overnight and then cooled to room temperature. To this was added a solution of zinc nitrate hexahydrate. The resulting slurry was dried in an oven gradually heated to 110° C. (>2 hours, 10° C./min.) then calcined. To this was added a solution of platinum nitrate (Chempur) in distilled water and a solution of tin oxalate (Alfa Aesar) (1.74 g) in dilute nitric acid (1N, 8.5 ml) The resulting slurry was dried in an oven gradually heated to 110° C. (>2 hours, 10° C./min.). The impregnated catalyst mixture was then calcined at 500° C. (6 hours, 1° C./min).

### Example 7

### TiO₂—CaSiO₃(5)-Pt(3)-Sn(1.8)

The material was prepared by first adding CaSiO₃ to the TiO₂ catalyst (Anatase, 14/30 mesh) support, followed by the addition of Pt/Sn as described in Example 1. First, an aqueous suspension of CaSiO₃ 200 mesh) was prepared by adding 0.52 g of the solid to 7.0 ml of deionized H₂O, followed by the addition of 1.0 ml of colloidal SiO₂ (15 wt % solution, NALCO). The suspension was stirred for 2 h at room temperature and then added to 10.0 g of TiO₂ catalyst support (14/30 mesh) using incipient wetness technique. After standing for 2 hours, the material was evaporated to dryness, followed by drying at 120° C. overnight under circulating air and calcination at 500° C. for 6 hours. All of the TiO₂—CaSiO₃ material was then used for Pt/Sn metal impregnation using 0.6711 g (1.73 mmol) of Pt(NH₃)₄(NO₃)₂ and 0.4104 g (1.73 mmol) of Sn(OAc)₂ following the procedure described in Example 1. Yield: 11.5 g of light grey material.

### Example 8

### Pt(2)-Sn(2) on High Surface Area Silica

Powdered and meshed high surface area silica NPSG SS61138 (100 g) of uniform particle size distribution of about 0.2 mm was dried at 120° C. in a circulating air oven atmosphere overnight and then cooled to room temperature. To this was added a solution of nitrate hexahydrate (Chempur). The resulting slurry was dried in an oven gradually heated to 110° C. (>2 hours, 10° C./min.) then calcined. To this was added a solution of platinum nitrate (Chempur) in distilled water and a solution of tin oxalate (Alfa Aesar) in dilute nitric acid. The resulting slurry was dried in an oven gradually heated to 110° C. (>2 hours, 10° C./min.). The impregnated catalyst mixture was then calcined at 500° C. (6 hours, 1° C./min).

### Example 9

### KA160-Pt(3)-Sn(1.8)

The material was prepared by incipient wetness impregnation of KA160 catalyst support (SiO₂-(0.05) Al₂O₃, Sud Chemie, 14/30 mesh) as described in Example 1. The metal solutions were prepared by first adding Sn(OAc)₂ (0.2040 g, 0.86 mmol) to a vial containing 4.75 me of 1:1 diluted glacial acetic acid. The mixture was stirred for 15 min at room temperature, and then, 0.3350 g (0.86 mmol) of solid Pt(NH₃)₄(NO₃)₂ were added. The mixture was stirred for another 15 min at room temperature, and then added drop wise to 5.0 g of dry KA160 catalyst support (14/30 mesh) in a 100 ml round-bottomed flask. All other manipulations, drying and calcination was carried out as described in Example 16. Yield: 5.23 g of tan-colored material.

### Example 10

### SiO₂−SnO₂(5)-Pt(1)-Zn(1)

Powdered and meshed high surface area silica NPSG SS61138 (100 g) of uniform particle size distribution of about 0.2 mm was dried at 120° C. in a circulating air oven atmosphere overnight and then cooled to room temperature. To this was added a solution of tin acetate (Sn(OAc)₂). The resulting slurry was dried in an oven gradually heated to 110° C. (>2 hours, 10° C./min.) then calcined. To this was added a solution of platinum nitrate (Chempur) in distilled water and a solution of tin oxalate (Alfa Aesar) in dilute nitric acid The resulting slurry was dried in an oven gradually heated to 110° C. (>2 hours, 10° C./min.). The impregnated catalyst mixture was then calcined at 500° C. (6 hours, 1° C./min).

### Example 11

### SiO₂−TiO₂(10)-Pt(3)-Sn(1.8)

The TiO₂-modified silica support was prepared as follows. A solution of 4.15 g (14.6 mmol) of Ti{OCH(CH₃)₂}₄ in 2-propanol (14 ml) was added dropwise to 10.0 g of SiO₂ catalyst support ( 1/16 inch extrudates) in a 100 ml round-bottomed flask. The flask was left standing for two hours at room temperature, and then evacuated to dryness using a rotor evaporator (bath temperature 80° C.). Next, 20 ml of deionized H₂O was slowly added to the flask, and the material was left standing for 15 min. The resulting water/2-propanol was then removed by filtration, and the addition of H₂O was repeated two more times. The final material was dried at 120° C. overnight under circulation air, followed by calcination at 500° C. for 6 hours. All of the SiO₂−TiO₂ material was then used for Pt/Sn metal impregnation using 0.6711 g (1.73 mmol) of Pt(NH₃)₄(NO₃)₂ and 0.4104 g (1.73 mmol) of Sn(OAc)₂ following the procedure described above for Example 1. Yield: 11.98 g of dark grey 1/16 inch extrudates.

### Example 12

### SiO₇−WO₃(10)-Pt(3)-Sn(1.8)

The WO₃-modified silica support was prepared as follows. A solution of 1.24 g (0.42 mmol) of (NH₄)₆H₂W₁₂O₄₀.n H₂O, (AMT) in deionized H₂O (14 ml) was added dropwise to 10.0 g of SiO₂ NPSGSS 61138catalyst support (SA=250 m²/g, 1/16 inch extrudates) in a 100 ml round-bottomed flask. The flask was left standing for two hours at room temperature, and then evacuated to dryness using a rotor evaporator (bath temperature 80° C.). The resulting material was dried at 120° C. overnight under circulation air, followed by calcination at 500° C. for 6 hours. All of the (light yellow) SiO₂−WO₃ material was then used for Pt/Sn metal impregnation using 0.6711 g (1.73 mmol) of Pt(NH₃)₄(NO₃)₂ and 0.4104 g (1.73 mmol) of Sn(OAc)₂ following the procedure described above for Example 1. Yield: 12.10 g of dark grey 1/16 inch extrudates.

### Example 13

### Comparative

Sn(0.5) on High Purity Low Surface Area Silica. Powdered and meshed high purity low surface area silica (100 g) of uniform particle size distribution of about 0.2 mm was dried at 120° C. in an oven under nitrogen atmosphere overnight and then cooled to room temperature. To this was added a solution of tin oxalate (Alfa Aesar) (1.74 g) in dilute nitric acid (1N, 8.5 ml). The resulting slurry was dried in an oven gradually heated to 110° C. (>2 hours, 10° C./min.). The impregnated catalyst mixture was then calcined at 500° C. (6 hours, 1° C./min).

### Example 14

### Gas Chromatographic (GC) Analysis of the Crude Product Hydrogenation

Catalyst of Examples 1-13 were tested to determine the selectivity and productivity to ethyl acetate and ethanol as shown in Table 4.

In a tubular reactor made of stainless steel, having an internal diameter of 30 mm and capable of being raised to a controlled temperature, there are arranged 50 ml of catalyst listed in Table 2. The length of the combined catalyst bed after charging was approximately about 70 mm. The reaction feed liquid of acetic acid was evaporated and charged to the reactor along with hydrogen and helium as a carrier gas with an average combined gas hourly space velocity (GHSV), temperature, and pressure as indicated in Table 4. The feed stream contained a mole ratio hydrogen to acetic acid as indicated in Table 4.

The analysis of the products was carried out by online GC. A three channel compact GC equipped with one flame ionization detector (FID) and 2 thermal conducting detectors (TCDs) was used to analyze the reactants and products. The front channel was equipped with an FID and a CP-Sil 5 (20 m)+WaxFFap (5 m) column and was used to quantify: Acetaldehyde; Ethanol; Acetone; Methyl acetate; Vinyl acetate; Ethyl acetate; Acetic acid; Ethylene glycol diacetate; Ethylene glycol; Ethylidene diacetate; and Paraldehyde. The middle channel was equipped with a TCD and Porabond Q column and was used to quantify: CO₂; ethylene; and ethane. The back channel was equipped with a TCD and Molsieve 5A column and was used to quantify: Helium; Hydrogen; Nitrogen; Methane; and Carbon monoxide.

Prior to reactions, the retention time of the different components was determined by spiking with individual compounds and the GCs were calibrated either with a calibration gas of known composition or with liquid solutions of known compositions. This allowed the determination of the response factors for the various components.

TABLE 4

| | | Reaction Conditions | | | | | | |
|---|---|---|---|---|---|---|---|---|
| | | Ratio of | Press. | Temp. | GHSV | Conv. of | Selectivity (%) | |
| Cat. Ex. | Cat. | H₂:AcOH | (KPa) | (° C.) | (hr⁻¹) | AcOH (%) | EtOAc | EtOH |
| 1 | SiO₂—CaSiO₃(5)-Pt(3)-Sn(1.8) | 5:1 | 2200 | 250 | 2500 | 24 | 6 | 92 |
| 2 | KA160-CaSiO₃(8)-Pt(3)-Sn(1.8) | 5:1 | 2200 | 250 | 2500 | 43 | 13 | 84 |
| 3 | SiO₂—CaSiO₃(2.5)-Pt(1.5)-Sn(0.9) | 10:1 | 1400 | 250 | 2500 | 26 | 8 | 86 |
| 4 | SiO₂ + MgSiO₃—Pt(1.0)-Sn(1.0) | 4:1 | 1400 | 250 | 6570 | 22 | 10 | 88 |
| 5 | SiO₂—CaSiO₃(5)-Re(4.5)-Pd(1) | 5:1 | 1400 | 250 | 6570 | 8 | 17 | 83 |
| 6 | SiO₂—ZnO(5)-Pt(1)-Sn(1) | 4:1 | 1400 | 275 | 6570 | 22 | 21 | 76 |
| 7 | TiO₂—CaSiO₃(5)-Pt(3)-Sn(1.8) | 5:1 | 1400 | 250 | 6570 | 38 | 78 | 22 |
| 8 | Pt(2)-Sn(2) on SiO₂ | 5:1 | 1400 | 296 | 6570 | 34 | 64 | 33 |
| 8 | Pt(2)-Sn(2) on SiO₂ | 5:1 | 1400 | 280 | 6570 | 37 | 62 | 36 |
| 8 | Pt(2)-Sn(2) on SiO₂ | 5:1 | 1400 | 250 | 6570 | 26 | 63 | 36 |
| 8 | Pt(2)-Sn(2) on SiO₂ | 5:1 | 1400 | 225 | 6570 | 11 | 57 | 42 |
| 9 | KA160-Pt(3)-Sn(1.8) | 5:1 | 2200 | 250 | 2500 | 61 | 50 | 47 |
| 10 | SiO₂—SnO₂(5)-Pt(1)-Zn(1) | 4:1 | 1400 | 275 | 6570 | 13 | 44 | 48 |
| 11 | SiO₂—TiO₂(10)-Pt(3)-Sn(1.8) | 5:1 | 1400 | 250 | 6570 | 73 | 53 | 47 |
| 12 | SiO₂—WO₃(10)-Pt(3)-Sn(1.8) | 5:1 | 1400 | 250 | 6570 | 17 | 23 | 77 |
| 13 | Sn(0.5) on SiO₂ | 9:1~8:1 | 2200 | 250 | 2500 | 10 | — | 1 |

### Example 15

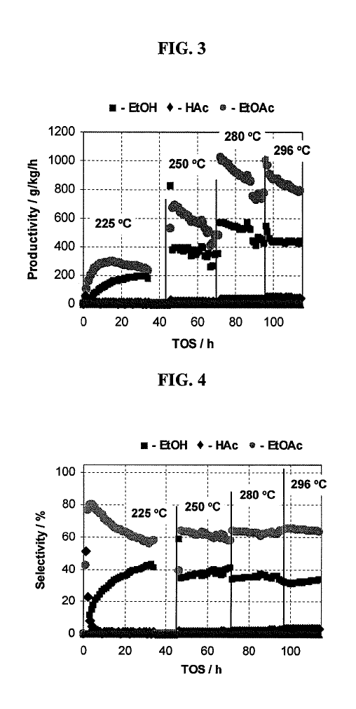

Vaporized acetic acid and hydrogen were passed over a hydrogenation catalyst of the present invention comprising 2 wt % Pt; and 2 wt % Sn on high surface area silica (NPSG SS61138) having a surface area of approximately 250 m²/g at a ratio of hydrogen to acetic acid of about 160 sccm/min H₂: 0.09 g/min HOAc, the hydrogen being diluted with about 60 sccm/min N₂ at a space velocity of about 6570 hr⁻¹ and a pressure of 200 psig (1379 kPag). The temperature was increased at about 50 hrs, 70 hrs and 90 hrs as indicated in FIG. 3 and FIG. 4. The productivity in grams of the indicated products (ethanol, acetaldehyde, and ethyl acetate) per kilogram of catalyst per hour are indicated in FIG. 3, and the selectivity of a catalyst for the various products are indicated in FIG. 4 with the upper line indicating productivity of or selectivity to ethyl acetate, the intermediate line indicating ethanol and the lower line indicating acetaldehyde. It is considered especially significant that production of, and selectivity for, acetaldehyde were low. FIGS. 3 and 4 demonstrate that the relative insensitivity of the catalyst to changes in temperature make this catalyst well-suited for use in a so-called adiabatic reactor in which the temperature may vary substantially over the catalyst bed due to the low and uneven rate of heat removal from the reactor.

While the invention has been described in detail, modifications within the spirit and scope of the invention will be readily apparent to those of skill in the art. In view of the foregoing discussion, relevant knowledge in the art and references discussed above in connection with the Background and Detailed Description, the disclosures of which are all incorporated herein by reference. In addition, it should be understood that aspects of the invention and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the invention.

We claim:

1. A catalyst, comprising a first metal, a second metal and a support, wherein the first metal is selected from the group consisting of nickel, palladium and platinum and is present in an amount greater than 1 wt %, based on the total weight of the catalyst, and wherein the second metal is selected from the group consisting of molybdenum, rhenium, zirconium, copper, cobalt, tin, and zinc and wherein the catalyst has a selectivity to ethyl acetate of greater than 40%.

2. The catalyst of claim 1, wherein the first metal is present in an amount greater than 1 wt. % and less than 25 wt %, based on the total weight of the catalyst.

3. The catalyst of claim 1, wherein the support is present in an amount of 25 wt. % to 99 wt. %, based on the total weight of the catalyst.

4. The catalyst of claim 1, wherein the support is selected from the group consisting of iron oxide, silica, alumina, silica/aluminas, titania, zirconia, magnesium oxide, calcium silicate, carbon, graphite, high surface area graphitized carbon, activated carbons, and mixtures thereof.

5. The catalyst of claim 1, further comprising at least one support modifier selected from the group consisting of (i) alkaline earth metal oxides, (ii) alkali metal oxides, (iii) alkaline earth metal metasilicates, (iv) alkali metal metasilicates, (v) Group IIB metal oxides, (vi) Group IIB metal metasilicates, (vii) Group IIIB metal oxides, (viii) Group IIIB metal metasilicates, and mixtures thereof.

6. The catalyst of claim 1, further comprising at least one support modifier selected from the group consisting of oxides of Group IVB metals, oxides of Group VB metals, oxides of Group VIB metals, iron oxides, aluminum oxides and mixtures thereof.

7. The catalyst of claim 1, wherein the second metal is present in an amount of from 0.1 to 10 wt. %, based on the total weight of the catalyst.

8. The catalyst of claim 1, wherein the catalyst has a selectivity to methane, ethane, and carbon dioxide of less than 4%.

9. The catalyst of claim 1, wherein the catalyst has a productivity that decreases less than 6% per 100 hours of catalyst usage.

10. The catalyst of claim 1, wherein the catalyst has a surface area of from 50 m²/g to 600 m²/g.

11. A process for preparing a catalyst, comprising:
(a) contacting a first metal precursor to a first metal with a support, wherein the first metal is selected from the group consisting of nickel, palladium and platinum;
(b) contacting a second metal precursor to a second metal with the support, wherein the second metal is selected from the group consisting of molybdenum, rhenium, zirconium, copper, cobalt, tin, and zinc; and
(c) heating the support under conditions effective to reduce the first metal and the second metal and form the catalyst, wherein the catalyst comprises the first metal in an amount greater than 1 wt %, based on the total weight of the catalyst.

12. The process of claim 11, wherein the heating occurs after steps (a) and (b).

13. The process of claim 11, wherein the heating occurs between steps (a) and (b) to reduce the first metal and after steps (a) and (b) to reduce the second metal.

14. A catalyst comprising a first metal, a second metal and a silica/alumina support, wherein the first metal is selected from the group consisting of nickel, palladium and platinum, the second metal is selected from the group consisting of molybdenum, rhenium, zirconium, copper, cobalt, tin, and zinc, and wherein the silica/alumina support comprises aluminum in an amount greater than 1 wt. %, based on the total weight of the high surface area silica/alumina support and has a surface area of at least 150 m²/g and wherein the catalyst has a selectivity to ethyl acetate of greater than 40%.

15. A catalyst, comprising a first metal, a second metal and a support, wherein the first metal is selected from group consisting of nickel and palladium, and wherein the second metal is selected from the group consisting of tin and zinc, wherein the catalyst has a selectivity to ethyl acetate of greater than 40%.

16. The catalyst of claim 15, wherein the first metal is present in an amount from 0.1 to 25 wt. %, based on the total weight of the catalyst.

17. The catalyst of claim 15, wherein the support is present in an amount from 25 wt % to 99.9 wt %, based on the total weight of the catalyst.

18. The catalyst of claim 15, wherein the support has a surface area of from 50 m²/g to 600 m²/g.

19. The catalyst of claim 15, wherein the support is selected from the group consisting of iron oxide, silica, alumina, silica/aluminas, titania, zirconia, magnesium oxide, calcium silicate, carbon, graphite, high surface area graphitized carbon, activated carbons, and mixtures thereof.

20. The catalyst of claim 15, further comprising at least one support modifier selected from the group consisting of (i) alkaline earth metal oxides, (ii) alkali metal oxides, (iii) alkaline earth metal metasilicates, (iv) alkali metal metasilicates, (v) Group IIB metal oxides, (vi) Group IIB metal metasilicates, (vii) Group IIIB metal oxides, (viii) Group IIIB metal metasilicates, and mixtures thereof.

21. The catalyst of claim 15, further comprising at least one support modifier selected from the group of oxides of Group IVB metals, oxides of Group VB metals, oxides of Group VIB metals, iron oxides, aluminum oxides and mixtures thereof.

22. The catalyst of claim 15, wherein the second metal is present in an amount of from 0.1 to 10 wt. %, based on the total weight of the catalyst.

23. The catalyst of claim 15, wherein the catalyst has a selectivity to methane, ethane, and carbon dioxide and mixtures thereof of less than 4%.

24. The catalyst of claim 15, wherein the catalyst has a productivity that decreases less than 6% per 100 hours of catalyst usage.

25. The catalyst of claim 15, wherein the catalyst has a selectivity to ethyl acetate of greater than 50%.

26. A process for preparing a catalyst, comprising:
(a) contacting a first metal precursor to a first metal with a support, wherein the first metal is selected from the group consisting of nickel and palladium;
(b) contacting a second metal precursor to a second metal with the support, wherein the second metal is selected from the group consisting of tin and zinc; and
(c) heating the support under conditions effective to reduce the first metal and the second metal and form the catalyst.

27. The process of claim 26, wherein the heating occurs after steps (a) and (b).

28. The process of claim 26, wherein the heating occurs between steps (a) and (b) to reduce the first metal and after steps (a) and (b) to reduce the second metal.

29. The process of claim 26, wherein step (b) occurs before step (a).

30. A catalyst, comprising a first metal, a support, and at least one support modifier selected from the group of oxides of Group IVB metals, oxides of Group VB metals, oxides of Group VIB metals, iron oxides, aluminum oxides and mixtures thereof.

31. The catalyst of claim 30, wherein the first metal is selected from the group consisting of Group IB, IIB, IIIB, IVB, VB, VIIB, VIIB, or VIII transitional metal, a lanthanide metal, an actinide metal or a metal from any of Groups IIIA, IVA, VA, or VIA.

32. The catalyst of claim 30, wherein the first metal is selected from the group consisting of copper, iron, cobalt, nickel, ruthenium, rhodium, palladium, osmium, iridium, platinum, titanium, zinc, chromium, rhenium, molybdenum, and tungsten.

33. The catalyst of claim 30, wherein the first metal is present in an amount of from 0.1 to 25 wt. %, based on the total weight of the catalyst.

34. The catalyst of claim 30, wherein the at least one support modifier is selected from the group consisting of WO₃, MoO₃, Fe₂O₃, Cr₂O₃, TiO₂, ZrO₂, Nb₂O₅, Ta₂O₅, and Al₂O₃.

35. The catalyst of claim 30, wherein the at least one support modifier is present in an amount of 0.1 wt. % to 50 wt. %, based on the total weight of the catalyst.

36. The catalyst of claim 30, wherein the support is present in an amount of 25 wt. % to 99 wt. %, based on the total weight of the catalyst.

37. The catalyst of claim 30, wherein the support is selected from the group consisting of iron oxide, silica, alumina, silica/aluminas, titania, zirconia, magnesium oxide, calcium silicate, carbon, graphite, high surface area graphitized carbon, activated carbons, and mixtures thereof.

38. The catalyst of claim 31, wherein the catalyst further comprises a second metal different from the first metal.

39. The catalyst of claim 38, wherein the first metal is platinum and the second metal is tin.

40. The catalyst of claim 39, wherein the molar ratio of platinum to tin is from 0.65:0.35 to 0.95:0.05.

41. The catalyst of claim 38, wherein the first metal is palladium and the second metal is rhenium.

42. The catalyst of claim 41, wherein the molar ratio of rhenium to palladium is from 0.65:0.35 to 0.95:0.05.

43. The catalyst of claim 38, wherein the second metal is selected from the group consisting of copper, molybdenum, tin, chromium, iron, cobalt, vanadium, tungsten, palladium, platinum, lanthanum, cerium, manganese, ruthenium, rhenium, gold, and nickel.

44. The catalyst of claim 38, wherein the second metal is present in an amount of from 0.1 to 10 wt. %, based on the total weight of the catalyst.

45. The catalyst of claim 38, wherein the catalyst further comprises a third metal different from the first and second metals.

46. The catalyst of claim 45, wherein the third metal is selected from the group consisting of cobalt, palladium, ruthenium, copper, zinc, platinum, tin, and rhenium.

47. The catalyst of claim 45, wherein the third metal is present in an amount of 0.05 and 4 wt. %, based on the total weight of the catalyst.

48. The catalyst of claim 30, wherein the catalyst has a selectivity to ethyl acetate of at least 40%.

49. The catalyst of claim 30, wherein the catalyst has a selectivity to methane, ethane, and carbon dioxide and mixtures thereof of less than 4%.

50. The catalyst of claim 30, wherein the catalyst has a productivity that decreases less than 6% per 100 hours of catalyst usage.

51. A process for preparing a catalyst, the process comprising the steps of:
(a) contacting a first metal precursor to a first metal with a modified support comprising at least one support modifier selected from the group of oxides of Group IVB metals, oxides of Group VB metals, oxides of Group VIB metals, iron oxides, aluminum oxides and mixtures thereof; and
(b) heating the modified support under conditions effective to reduce the first metal and form the catalyst, wherein the catalyst has a selectivity to ethyl acetate of greater than 40%.

52. The process of claim 51, wherein the heating occurs after steps (a) and (b).

53. The process of claim 51, wherein the heating occurs between steps (a) and (b) to reduce the first metal and after steps (a) and (b) to reduce the second metal.

54. The process of claim 51, further comprising the steps of:
(c) contacting the at least one support modifier or a precursor thereof with a support material to form a modified support precursor; and
(d) heating the modified support precursor under conditions effective to form the modified support.
